(19) United States
(12) Patent Application Publication
(10) Pub. No.: US 2015/0169128 A1
(43) Pub. Date: Jun. 18, 2015

(54) TOUCH DISPLAY APPARATUS

(71) Applicant: Intellectual Discovery Co., Ltd., Seoul (KR)

(72) Inventors: Hyun-Ha Hwang, Seoul (KR); Heon-Kyu Kim, Suwon-si (KR)

(73) Assignee: INTELLECTUAL DISCOVERY CO., LTD., Seoul (KR)

(21) Appl. No.: 14/411,780

(22) PCT Filed: Jul. 1, 2013
(86) PCT No.: PCT/KR2013/005824

§ 371 Date: Dec. 29, 2014

(30) Foreign Application Priority Data
Jun. 29, 2012 (KR) 10-2012-0070719

(51) Int. Cl. G06F 3/041; G02F 1/1343; G02F 1/1333

(52) U.S. Cl. CPC G06F 3/0416; G02F 1/13338; G02F 1/134309; G06F 3/0412; G02F 2001/134318

(57) ABSTRACT

A touch display apparatus according to an embodiment of the present invention includes a display part, a common voltage generating part, a plurality of driving parts and a plurality of charge sensing parts. Thea display part includes a first substrate, a second substrate disposed opposite to the first substrate, a liquid crystal layer disposed between the first and second substrates, a common electrode formed between the first and second substrates, and a plurality of pixel electrodes formed respectively in pixels between the first and second substrates. The common voltage generating part is electrically connected to the common electrode to provide the common electrode with a common voltage. The plurality of driving parts is electrically connected to the pixel electrodes, respectively to provide the pixel electrode with a pixel voltage. The plurality of charge sensing parts is electrically connected to the pixel electrodes to sense electric charge of the pixel electrodes. Since the charge sensing parts electrically connected to the pixel electrodes, respectively sense changes of electric charges of each of the pixel electrodes to detect touch input, no additional capacitive type touch input part is required to reduce manufacturing cost.

### TECHNICAL FIELD

The present invention relates to a touch display apparatus, and more particularly to a capacitive type touch display apparatus.

### BACKGROUND ART

A general touch display apparatus includes a display part displaying an image and a touch input part on the display part. The touch input part includes a pressure type, a resistive type, a capacitive type, an ultrasonic type, etc. Recently, the capacitive type touch input part is frequently employed.

According to the capacitive type touch input part, a touch point performed by a touch object is detected through sensing change of capacitance or charge. In order for that, the capacitive type touch input part includes a transparent electrode for an input by the touch object. The transparent electrode is generally formed on a transparent film or a glass.

As described above, the capacitive type touch display apparatus must include a display part for displaying an image and a capacitive type touch input part for receiving touch input. Therefore, a manufacturing cost of the capacitive type touch display apparatus increases because of employing the capacitive type touch input part.

### DISCLOSURE

### Technical Problem

Therefore, the technical problem of the present invention is to provide a touch display apparatus capable of reducing a manufacturing cost thereof.

### Technical Solution

A touch display apparatus according to an embodiment of the present invention includes a display part, a common voltage generating part, a plurality of driving parts and a plurality of charge sensing parts.

Thea display part includes a first substrate, a second substrate disposed opposite to the first substrate, a liquid crystal layer disposed between the first and second substrates, a common electrode formed between the first and second substrates, and a plurality of pixel electrodes formed respectively in pixels between the first and second substrates. The common voltage generating part is electrically connected to the common electrode to provide the common electrode with a common voltage. The plurality of driving parts is electrically connected to the pixel electrodes, respectively to provide the pixel electrode with a pixel voltage. The plurality of charge sensing parts is electrically connected to the pixel electrodes to sense electric charge of the pixel electrodes.

The charge sensing parts may be electrically connected to the pixel electrodes through the driving parts. In this case, each of the driving parts may include a first switch for providing the pixel electrode with the pixel voltage, and a second switch for connecting the pixel electrode and the charge sensing part. Further, each of the driving parts may further include a third switch for providing the pixel electrode with a ground voltage.

Each of the charge sensing parts may be electrically connected to at least two pixel electrodes neighboring with each other.

A common voltage switch for determining providing the common voltage may be connected between the common voltage generating part and the common electrode.

The common electrode may be formed on the first substrate, and the pixel electrodes may be formed on the second substrate such that the pixel electrodes faces the common electrode. Alternatively, each of the pixel electrodes may include pixel electrode patterns divided and formed on one of the first and second substrate, and the common electrode may include common electrode patterns formed on the one of the first and second substrate and disposed between the pixel electrode patterns.

A method according to an embodiment of the present invention relates to a method of driving a touch display apparatus comprising a display part including a liquid crystal layer disposed between first and second substrates, a common electrode formed between the first and second substrates and a plurality of pixel electrodes formed between the first and second substrates, and a plurality of charge sensing parts electrically connected to the pixel electrodes.

The method may include displaying an image by providing the common electrode and the pixel electrodes with predetermined voltages, and sensing electric charge of pixel electrodes while the common electrode is in a floating state after displaying an image.

The sensing electric charge may include a TA step providing each of the pixel electrodes with a predetermined voltage, and a TB step sensing electric charge of each of the pixel electrodes while making the common electrode in a floating state.

The method may further include setting up the common electrode and the pixel electrode to be a same voltage between display an image and sensing electric charge.

### Advantageous Effects

According to the touch display apparatus, the charge sensing parts electrically connected to the pixel electrodes, respectively sense changes of electric charges of each of the pixel electrodes to detect touch input. Therefore, no additional capacitive type touch input part is required to reduce manufacturing cost.

### DESCRIPTION OF DRAWINGS

FIG. 1 is a conceptual view showing a touch display apparatus according to a first exemplary embodiment of the present invention.

FIG. 2 is a drawing showing a status before touch input to a first pixel electrode of the touch display apparatus in FIG. 1.

FIG. 3 is a drawing showing a status after touch input to a first pixel electrode of the touch display apparatus in FIG. 1.

FIG. 4 is a conceptual view showing a touch display apparatus according to a second exemplary embodiment of the present invention.

FIG. 5 is a chart showing a method of driving a touch display apparatus according to a third exemplary embodiment of the present invention.

FIG. 6 is a conceptual view showing a touch display apparatus according to a fourth second exemplary embodiment of the present invention.

### MODE FOR INVENTION

The present invention may be embodied in many different forms, and the present invention will be described more fully hereinafter with reference to the accompanying drawings.

However, the present invention should not be construed as limited to the example embodiments set forth herein and should be understood to include various modifications and variation within the spirit or scope of the invention. It will be understood that, although the terms first, second, third etc. may be used herein to describe various components but the preset invention should not be limited by these terms. These terms are only used to distinguish one element from another element. For example, a first element could be termed a second element, and a second element could be termed a first element within the scope of the present invention.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, with reference to the drawings, preferred embodiments of the present invention will be described in detail.

### Embodiment 1

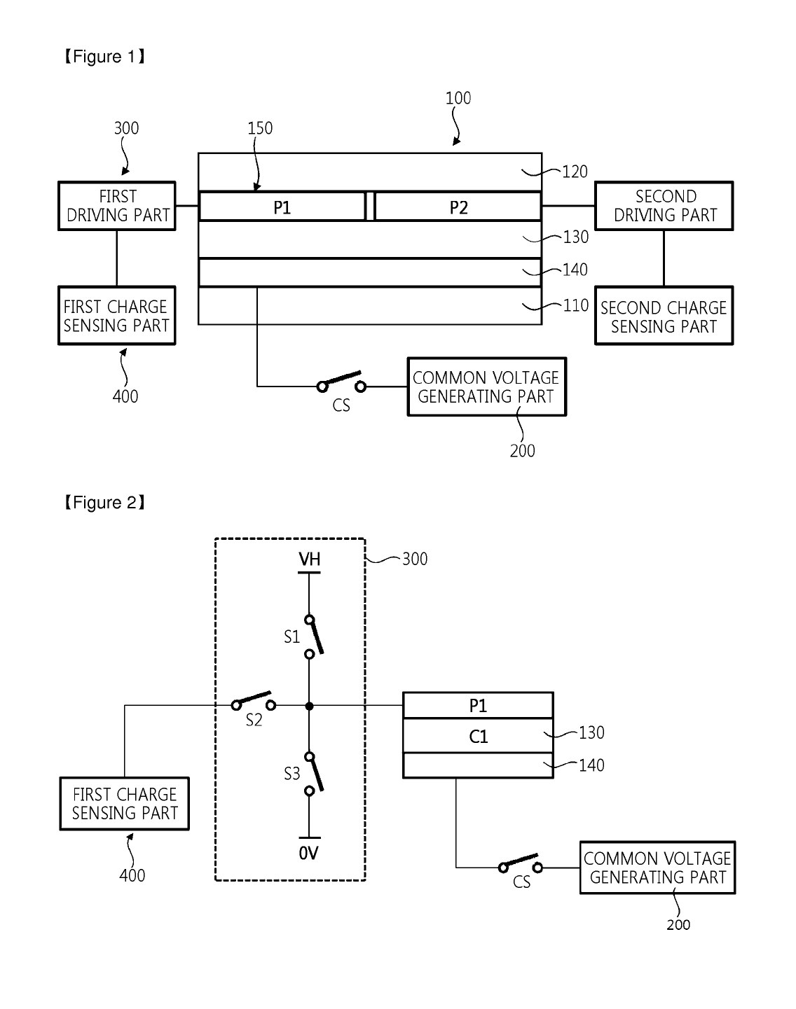

FIG. 1 is a conceptual view showing a touch display apparatus according to a first exemplary embodiment of the present invention, and FIG. 2 is a drawing showing a status before touch input to a first pixel electrode of the touch display apparatus in FIG. 1. FIG. 1 is a

Referring to FIG. 1 and FIG. 2, a touch display apparatus according to the present invention includes a display part 100 display an image, a common voltage generating part 200 providing the display part 100 with a common voltage, a plurality of driving parts 300 controlling the display part 100, and charge sensing parts 400 sensing touch input on the display part 100.

The display part 100 may be a liquid crystal display including a first substrate 110, a second substrate 120 disposed opposite to the first substrate 110, a liquid crystal layer 130 disposed between the first and second substrates 110 and 120, a common electrode 140 formed on the first substrate 110, and a plurality of pixel electrodes 150 formed on the second substrate 120. In FIG. 1, only a first pixel electrode P1 and a second pixel electrode P2 are shown as the pixel electrodes 150, for example.

The common voltage generating part 200 is electrically connected to the common electrode 140 to provide the common electrode 140 with a common voltage. In this case, a common voltage switch CS may be disposed between the common voltage generating part 200 and the common electrode 140.

The driving parts 300 are electrically connected to the pixel electrodes 150, respectively to provide the pixel electrodes 150 with a pixel voltage VH. In FIG. 1, only a first driving part electrically connected to the first pixel electrode P1, and a second driving part electrically connected to the second pixel electrode P2 are shown as the driving parts 300, for example.

The charge sensing parts 400 are electrically connected to the pixel electrodes through the driving parts 300, respectively. The charge sensing parts 400 sense charges of the pixel electrodes 150 to sense touch input when an external object such as a human finger touches the pixel electrodes 150. In FIG. 1, only a first charge sensing part electrically connected to the first pixel electrode P1 through a first driving part, and a second charge sensing part electrically connected to the second pixel electrode P2 through a second driving part are shown as the charge sensing part, for example.

In the present embodiment, each of the driving parts 300, for example, a first driving part may include a first switch S1 for providing the first pixel electrode P1 with the pixel voltage VH, a second switch S2 for connecting the first pixel P1 to the first charge sensing part, and a third switch S3 for providing a ground voltage, for example, 0V to the first pixel electrode P1.

The touch display apparatus displays an image through the first pixel electrode P1 when the common voltage switch CS and the first switch S1 are turned on so that the common voltage is applied to the common electrode 140 and the pixel voltage VH is applied to the first pixel electrode P1.

Herein after, charge sensing operation of the touch display apparatus will be explained.

Referring to FIG. 2, the first switch S1 is turned on for a short time to apply the pixel voltage VH to the first pixel electrode P1, and then the first switch S1 is turned off and the third switch S3 is turned on so that the first charge sensing part senses electric charge.

In this case, the electric charge Q sensed before touch input is equal to a value obtained by multiplying the pixel voltage VH with the liquid crystal capacitance C1 as shown in the following Expression 1.

Q=C1·VH Expression 1

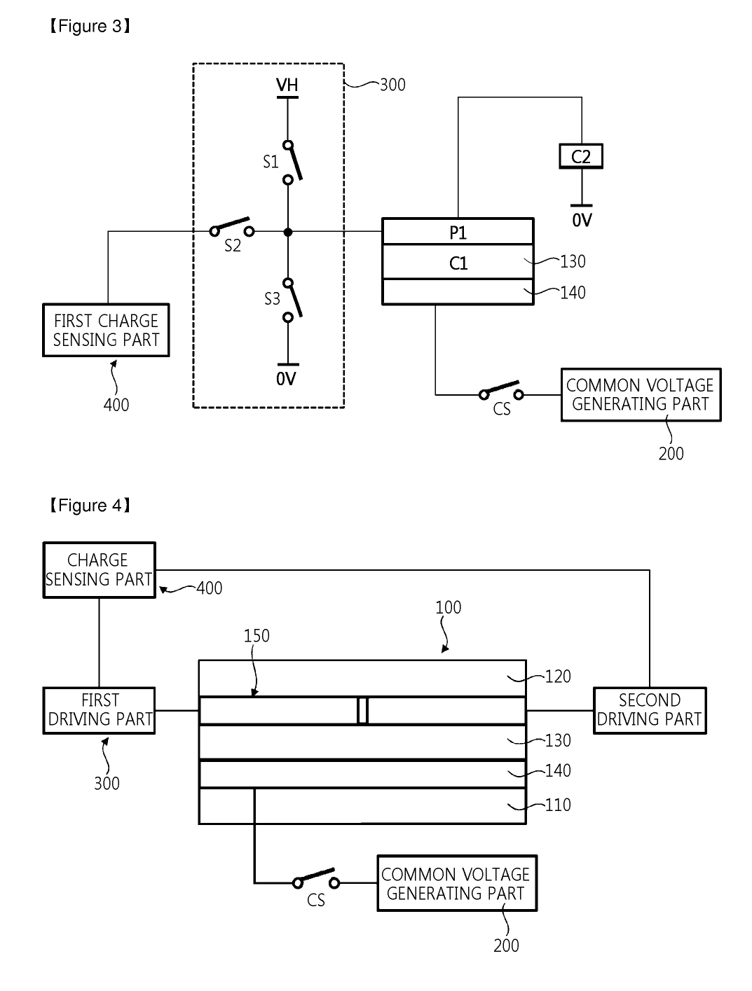

FIG. 3 is a drawing showing a status after touch input to a first pixel electrode of the touch display apparatus in FIG. 1.

Then, referring to FIG. 3, same operation is performed after the touch input. That is, the first switch S1 is turned on for a short time to apply the pixel voltage VH to the first pixel electrode P1, and then the first switch S1 is turned off and the second switch S2 is turned on so that the first charge sensing part senses electric charge again.

In this case, the electric charge Q sensed after the touch input is equal to a value obtained by multiplying the pixel voltage VH with the summed capacitance (C1+C2) of the liquid crystal capacitance C1 and the capacitance C2 of the touch object as shown in the following Expression 2.

Q=(C1+C2)·VH Expression 2

Therefore, through the Expression 1 and Expression 2, the change of the electric charge on the first pixel electrode P1 can be sensed to sense the existence of touch input.

Hereinbefore, for example, a display operation and a sensing operation of the first pixel P1 are explained, but a display operation and a sensing operation of other pixels 150 may be performed as the first pixel.

As described above, according to the present invention, the charge sensing parts 400 electrically connected to the pixel electrodes 150, respectively, sense the change of electric charge to confirm touch event. Therefore, no additional touch input part is required to reduce manufacturing cost.

### Embodiment 2

FIG. 4 is a conceptual view showing a touch display apparatus according to a second exemplary embodiment of the present invention.

The touch display apparatus of FIG. 4 is substantially same as the touch display apparatus of Embodiment 1 explained through FIG. 1 through FIG. 3 except for correspondence relation between the driving parts 300 and the charge sensing parts 400. Therefore, same reference numerals are applied to same elements and any further explanation will be omitted.

Referring to FIG. 4, each of the charge sensing parts 400 according to the present embodiment is electrically connected to at least two pixel electrodes 150 neighboring with each other through at least two driving parts 300. For example, one of the charge sensing parts 400 may be electrically connected to first and second pixel electrodes P1 and P2 through first and second driving parts. That is, the charge sensing part 400, the driving part 300 and the pixel electrode may be connected such that the number of the charge sensing part 400, the driving part 300 and the pixel electrode 150 may be 1:2:2.

According to the present embodiment, electric charge of at least two pixel electrodes 150 may be sensed together so that minute change induced by minute area of the pixel electrode can be detected to prevent error of touch sensing, and a problem of raising the pixel voltage VH for increasing change of electric charge may be solved.

### Embodiment 3

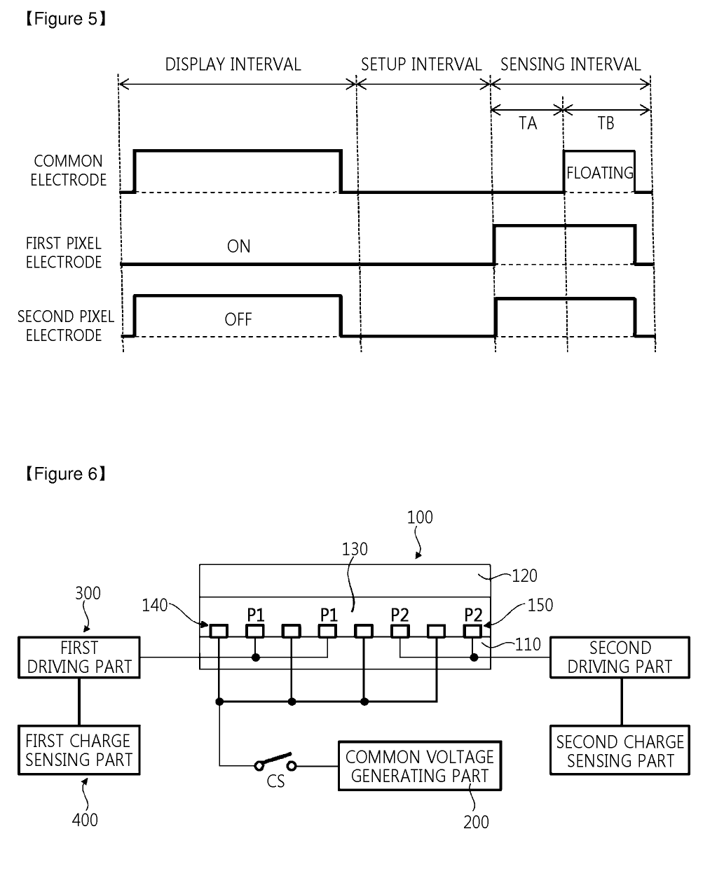

FIG. 5 is a chart showing a method of driving a touch display apparatus according to a third exemplary embodiment of the present invention.

The touch display apparatus of the present embodiment is substantially same as the touch display apparatus of Embodiment 1 explained through FIG. 1 through FIG. 3 except for a driving method. Therefore, same reference numerals are applied to same elements and any further explanation will be omitted.

Referring to FIG. 5, the touch display apparatus according to the present embodiment is driven by repeating a display interval, a setup interval and a sensing interval.

In detail, a pixel voltage VH is applied to a common electrode 140 and predetermined voltages are applied to the first and second pixel electrodes P1 and P2, respectively to perform a display operation in the display interval. In FIG. 5, for an example, a voltage difference is induced between the first pixel electrode P1 and the common electrode 140 to display ON state through the first pixel electrode P1, and a voltage difference is not induced between the second pixel electrode P2 and the common electrode 140 to display OFF state through the second pixel electrode P2.

Then, same voltage, for example 0V is applied to the common electrode 140, the first pixel electrode P1 and the second electrode P2 to reset them in the set up interval. In this case, the setting of the first and second pixel electrodes P1 and P2 may be performed through the third switch S3. Through this setting interval, inducing electric charge of the liquid crystal may be minimized.

The sensing interval may include a TA interval and a TB interval. In the TA interval a voltage is applied to the first and second pixel electrodes P1 and P2. In the TB interval, electric charges of the first and second pixel electrodes P1 and P2 are detected. In this case, applying voltage is blocked by the common voltage switch CS to make the common electrode 140 to be in a floating state.

According to the present embodiment, the touch display apparatus is operated by repeating the display interval, the setup interval and the sensing interval, and electric charge is sensed at the common electrode 140 in the floating state, so that change of electric charge in the pixel electrode 140 can be precisely sensed.

Referring to Expression 1 and Expression 2 of the first embodiment, C2 of user's finger may be tens of pF. Therefore, when C1 is much greater than C2 (C1>>C2), precise detecting of touch input may be difficult.

In detail, for example, when C1 is numbers of pF, that is C1=100·C2, change of electric charge before and after touch input may be 1%. When touch input is sensed through this small amount of change of electric charge, an error may be committed. In real case, there exists liquid crystal layer between the pixel electrode and the common electrode to make the capacitance greater when pixel voltage is applied thereto in display operation.

Therefore, in order not to generate great capacitance in liquid crystal to be in a state that C1>>C2, the common electrode 140 is made to be in the floating state in the sensing interval to sense electric charge. Therefore, change of electric charge in each of the pixel electrode 140 may be precisely detected.

### Embodiment 4

FIG. 6 is a conceptual view showing a touch display apparatus according to a fourth second exemplary embodiment of the present invention.

The touch display apparatus in FIG. 6 is substantially same as the touch display apparatus of Embodiment 1 explained through FIG. 1 through FIG. 3 except for a position and a shape of a common electrode 140 and pixel electrodes 150. Therefore, same reference numerals are applied to same elements and any further explanation will be omitted.

Referring to FIG. 6, each of the pixel electrodes 150, for example each of the first and second pixel electrodes P1 and P2 includes a pixel electrode pattern divided and formed on the first substrate 110. The common electrode 140 includes a common electrode patterns formed on the first substrate 110 and disposed between corresponding the pixel electrode patterns. For example, the pixel electrode pattern and the common electrode pattern is formed on the first substrate, but alternatively the pixel electrode pattern and the common electrode pattern may be formed on the second substrate.

According to the present embodiment, the electric fields generated between the pixel electrode pattern and the common electrode pattern adjust optical transmittance of the liquid crystal layer 130 to display an image.

1. A touch display apparatus comprising:
a display part including a first substrate, a second substrate disposed opposite to the first substrate, a liquid crystal layer disposed between the first and second substrates, a common electrode formed between the first and second substrates, and a plurality of pixel electrodes formed respectively in pixels between the first and second substrates;
a common voltage generating part electrically connected to the common electrode to provide the common electrode with a common voltage;
a plurality of driving parts electrically connected to the pixel electrodes, respectively to provide the pixel electrode with a pixel voltage; and
a plurality of charge sensing parts electrically connected to the pixel electrodes to sense electric charge of the pixel electrodes.

2. The touch display apparatus of claim 1, wherein the charge sensing parts are electrically connected to the pixel electrodes through the driving parts.

3. The touch display apparatus of claim 2, wherein each of the driving parts comprises:
a first switch for providing the pixel electrode with the pixel voltage; and
a second switch for connecting the pixel electrode and the charge sensing part.

4. The touch display apparatus of claim 3, wherein each of the driving parts further comprises:
a second switch for providing the pixel electrode with a ground voltage.

5. The touch display apparatus of claim 1, wherein each of the charge sensing parts is electrically connected to at least two pixel electrodes neighboring with each other.

6. The touch display apparatus of claim 1, wherein a common voltage switch for determining providing the common voltage is connected between the common voltage generating part and the common electrode.

7. The touch display apparatus of claim 1, wherein the common electrode is formed on the first substrate, and the pixel electrodes are formed on the second substrate such that the pixel electrodes faces the common electrode.

8. The touch display apparatus of claim 1, wherein each of the pixel electrodes comprises pixel electrode patterns divided and formed on one of the first and second substrate, and
the common electrode comprises common electrode patterns formed on the one of the first and second substrate and disposed between the pixel electrode patterns.

9. A method of driving a touch display apparatus comprising a display part including a liquid crystal layer disposed between first and second substrates, a common electrode formed between the first and second substrates and a plurality of pixel electrodes formed between the first and second substrates, and a plurality of charge sensing parts electrically connected to the pixel electrodes, the method comprising:
displaying an image by providing the common electrode and the pixel electrodes with predetermined voltages; and
sensing electric charge of pixel electrodes while the common electrode is in a floating state after displaying an image.

10. The method of claim 9, wherein sensing electric charge comprises:
a TA step providing each of the pixel electrodes with a predetermined voltage; and
a TB step sensing electric charge of each of the pixel electrodes while making the common electrode in a floating state.

11. The method of claim 9, further comprising setting up the common electrode and the pixel electrode to be a same voltage between display an image and sensing electric charge.
